(19) United States
(12) Patent Application Publication
(10) Pub. No.: US 2005/0184988 A1
(43) Pub. Date: Aug. 25, 2005

(54) Graphical apparatus and method for tracking image volume review

(76) Inventors: Jeffrey H. Yanof, Solon, OH (US); Melinda Steinmiller, Pembroke, FL (US); Shalabh Chandra, Twinsburg, OH (US); Himanshu Shukla, Gates Mills, OH (US)

Correspondence Address: PHILIPS INTELLECTUAL PROPERTY & STANDARDS, 595 MINER ROAD, CLEVELAND, OH, 44143, US

(21) Appl. No.: 10/510,861

(22) PCT Filed: Apr. 11, 2003
(86) PCT No.: PCT/US03/11083

(30) Foreign Application Priority Data
Apr. 12, 2002 (US) 60372060

(51) Int. Cl. G06T 17/00

(52) U.S. Cl. 345/424

(57) ABSTRACT

An apparatus and graphical method for tracking image volume review is provided. An image volume data set is stored in a memory and selected portions of the image volume data set is displayed on a human readable display. A mapping of the displayed portion of the image volume data set is performed relative to a volume completion data set. The volume completion data set with the first portion thereof identified according to the mapping is colorized using a shading function to visually differentiate first portions of the volume completion data set reviewed by a radiologist from remaining portions of the volume completion data set. In that way, a complete review of the image volume can be conducted without missing portions thereof and without redundancy.

The present invention pertains to the image display arts. It finds particular application in conjunction with the display and review of CT medical diagnostic images on video monitors and will be described with particular reference thereto. However, it is to be appreciated that the invention is also applicable to the display and review of medical diagnostic images derived or generated from magnetic resonance, nuclear, and other imaging modalities, to quality assurance and other 3-dimensional, non-medical images, and the like. The invention is also applicable to hard copy displays, film image displays, and other display formats.

Heretofore, CT scanners have irradiated regions of a subject from various angles and detected the intensity of radiation passing therethrough. For 3-dimensional imaging, the patient was moved along a longitudinal axis of the CT scanner either continuously for spiral scanning or incrementally, to generate a multiplicity of slices. The image data were reconstructed and extrapolated or interpolated as necessary, to generate CT numbers corresponding to each of a 3-dimensional array of voxels. For simplicity of illustration, each of the CT numbers can be conceptualized as being addressable by its coordinate location along three orthogonal axes, e.g. x, y, and z-axes of the examined volume.

Typically, the image volume data set is stored in a memory device for communication and/or retrieval at a later date. This enables a convenient review of the patient images by radiologists or clinicians on a workstation or similar PC type system. Various planar representations of the image volume data set are now commonly available to radiologists using the workstation. Most commonly, the examined volume is a 6-sided prism or polyhedron with square or rectangular faces. The radiologist uses a pointing device such as a mouse to select a view depicting any one of the six faces of the prism or any one of the slices through an interior of the prism along any of the (x, y), (x, z) or (y, z) planes. Some display formats also permit oblique or curved planes to be selected. Display formats are also available which permit two or three sides of the prism to be displayed concurrently on a 2-dimensional (i, j) image plane with appropriate visual cues to give the impression of a perspective view in three dimensions.

When radiologists review a patient image volume data set, the traditional approach is to review the images in a sequential manner, e.g. review axial slices cranial to caudal, one image slice at a time in a fixed order on a page montage of images. However, an increased number of radiologists are reviewing patient cases on workstations and viewing stations rather than viewing the traditional image films. At these workstations, the radiologists typically cause a selected surface, such as a transverse (x, y) plane on the face (z=0) of the examined volume to be displayed. The radiologists could then cause a selected number of transverse planar slices to be ?peeled? away or deleted by indexing along the z-axis (z=1, 2, . . . Zₘₐₓ) to view the interior transverse planes. The radiologists could then position the cursor on the (x, y) or transverse plane to select a coronal or (x, z) plane. The selected coronal plane would then be displayed. The operator would then position the cursor on the displayed coronal plane and select a sagittal or (y, z) plane. Current medical image workstations commonly permit the transverse, coronal, or sagittal sections or views to be displayed concurrently in different view ports on the same screen.

Clearly, reviewing the patient image data set case on a computer workstation affords a great deal of flexibility in the review process. Viewing techniques for large image volumes currently available in medical imagers such as MD-CT devices with high temporal-spatial resolution may include cine, montage paging, slabs with variable thickness, and oblique multi-planar reformatting (MPR). Such search methods may have sequential or non-sequential navigation or may include gestaltian methodologies. These workstations have the ability to provide radiologists with large amounts of information in a small amount of time. Particularly, the user may cine through the image data in a ?back and forth? fashion along arbitrary paths, skip around the image volume, switching between sequential and problem solving search paradigms, review supplementary aspects of the volume in various selected MPR planes, review a suspicious area at a higher resolution and other areas at a lower resolution, or suspend the patient case review and return thereto at a later date or time.

One disadvantage of the prior art display systems described above, however, is that it is difficult for radiologists to keep track of which aspect(s) of the patient image volume have been reviewed carefully and which portions have not. Although the radiologists have full control over how images are displayed on the screen, without proceeding through the case study sequentially, it is difficult to record or categorize portions of the image volume previously studied.

One solution is the use of redundant reading. However, this costs time and is therefore wasteful. Further, the redundant reading technique does not guarantee that all relevant portions of the image volume are read. Also, in another solution, radiologists might maintain a mental checklist of those solid organs which have been reviewed and those which have not. As an example, in the abdomen, the review sequence might include a review of the liver first, followed by kidneys, spleen, and so forth. However, this strategy is not particularly effective in the chest, for instance, as there may be one or more large areas of the lung parachyma that need to be reviewed and the sub-volumes are less delineated by discreet anatomical objects. In this case, the radiologist can simply become ?lost? within an organ image.

The present invention contemplates new and improved apparatus and graphical methods for tracking image volume review which permit the review of patient studies on workstations without the risk of inadvertent omission of a review of critical portions of the patient image volume. The device and methods disclosed herein provide graphical feedback during the review process and in correlation with the anatomical image volume as to which aspects of the image volume have been reviewed. This enables the radiologists to search through the data set as desired and substantially unscripted because the improved apparatus and methods disclosed herein provide feedback to the radiologists to ensure that all aspects of the image volume are evenly reviewed or studied without redundant reading.

The subject invention provides graphical feedback identifying those aspects of the image volume which have been reviewed, the detailed focus of that review including information relating to an amount of time which has been spent on each portion of the volume, and which aspects have been skipped or under-reviewed. This information is presented in a separate display viewport using a ?completion cube? or ?completion sphere? graphical format. As the radiologist displays images at the workstation, the completion cube is updated in the separate display viewport to indicate those aspects of the data set which have been reviewed and at what level of detail. A transform is provided to uniquely map the image volume to the completion cube. As portions of the image volume are displayed for review by a radiologist, the projections to the cube are automatically shaded or colorized as a function of the level of detail and/or time the image was displayed in accordance with a shading function. Mappings for various image reviews are described, for example axial, axial followed by coronal, oblique MPR, volume projections, and cine. The shading function can also be combined with image data on a projection or on an axial/sagittal/coronal base. The shaded cube is displayed simultaneously with the display of the patient image volume during the study. Data forming the cube can be achieved to memorialize the study or for retrieval at a later date.

In accordance with one aspect of the invention, a method of clinical review of images of patients includes providing an image volume data set of an anatomical structure. A plurality of selectable portions of the image volume data set are displayed on a human readable display device. Data identifying each of the plurality of selectable portions displayed on the human readable display is stored as a record of those portions of the anatomical structure studied by the radiologist. Preferably, the data identifying each of the plurality of selectable portions displayed on the human readable display device includes information relating to aspects of the data set which have been reviewed and data indicating the level of detail of review.

In accordance with a further aspect of the invention, a method of clinical review of images of patients includes generating an image volume data set of the patient on a scanner device and storing the image volume data set in a memory of the scanner device. A first portion of the image volume data set is selected using input means of the associated scanner device. The first portion of the image volume data set is displayed as a first image of the patient on a human readable display of the scanner device. The first portion of the image volume data set displayed is mapped to a first portion of a volume completion data set. The volume completion data set is displayed as a completion cube image with the first portion of the volume completion data set of the completion cube identified according to a predetermined colorization function to visually differentiate the first portion of the volume completion data set from the remaining portion of the volume completion set.

In accordance with yet a further aspect of the invention, a method of clinical review of images of patients includes generating multiple image volume data sets of the patient using gating means in a scanner device triggered according to selected points in multi-phase studies such as liver and cardiac investigations. The image volume data sets are displayed individually on a display device simultaneously with a completion cube identifying portions of the volume image studied by radiologists. As an example, a volume completion cube is displayed corresponding to each image volume data set collected during heart cycles triggered during various phases thereof such as during ventricular contraction. As each phase is investigated, the completion cube is colorized to confirm that the particular phase was investigated or displayed.

One advantage of the present invention is that it provides radiologists with the ability to review image volumes of patients while tracking aspects of the image volume that have been reviewed carefully and which have not.

Another advantage of the invention is that it provides radiologists with the ability to suspend the review of patient image volume data sets as desired or necessary and then resume those reviews at a later time or date without the concern of overlooking portions of the image volume and without the potential waste of duplicated efforts due to redundant review.

Still other advantages and benefits of the invention will become apparent to those skilled in the art upon a reading and understanding of the following detailed description.

The invention may take physical form in certain parts and arrangements of parts, the preferred embodiments of which will be described in detail in the specification and illustrated in the accompanying drawings which form a part hereof, and wherein:

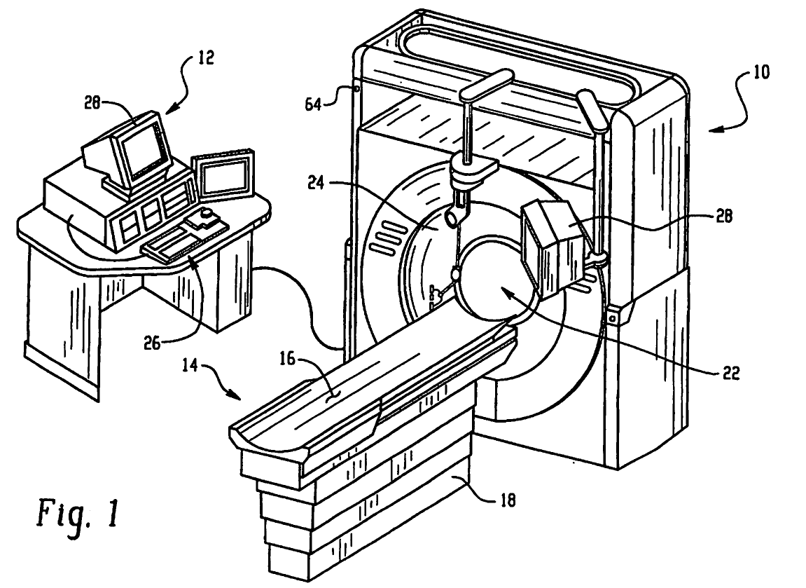

FIG. 1 is a diagrammatic illustration of a CT scanner system used in connection with the subject invention;

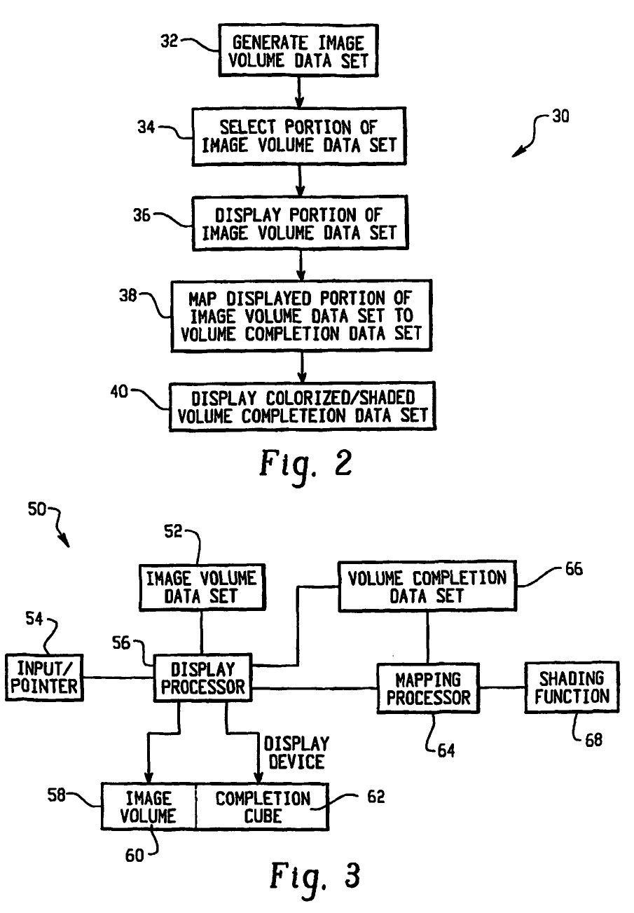

FIG. 2 is a flowchart illustrating the preferred method of practicing the invention;

FIG. 3 is a diagrammatic illustration of a workstation in accordance with the invention;

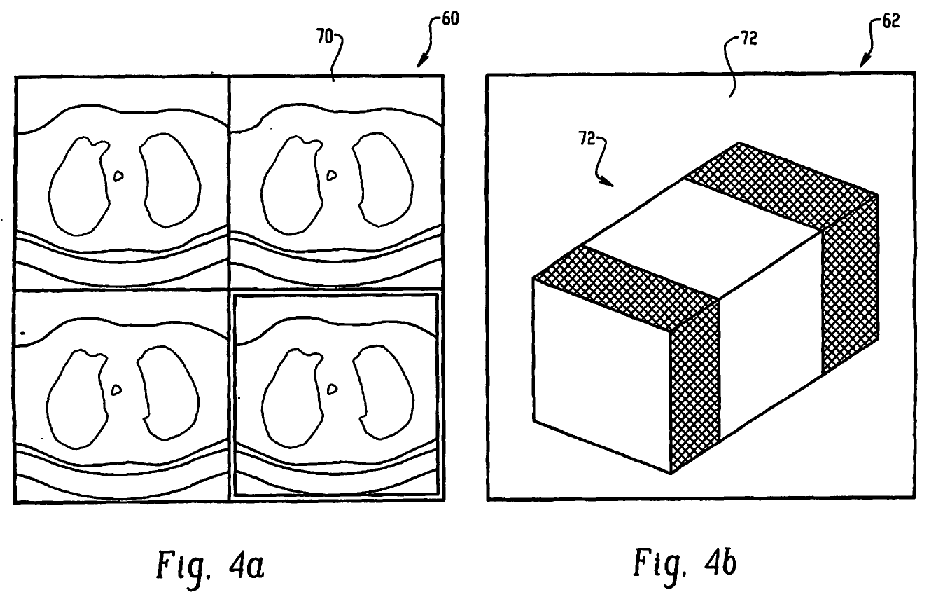

FIGS. 4a and 4b are views of a volume image display and a completion cube display presented to a radiologist in accordance with the invention;

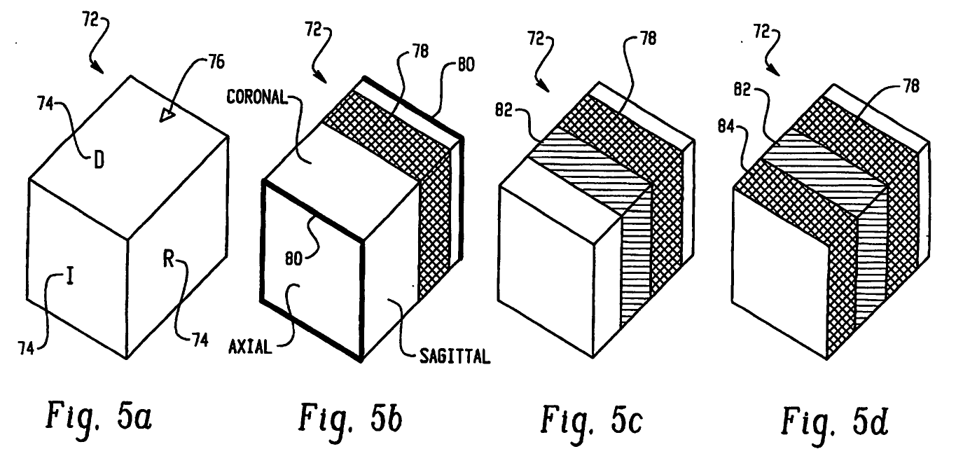

FIGS. 5a and 5b show examples of the completion cube image presented to a radiologist during a patient image study;

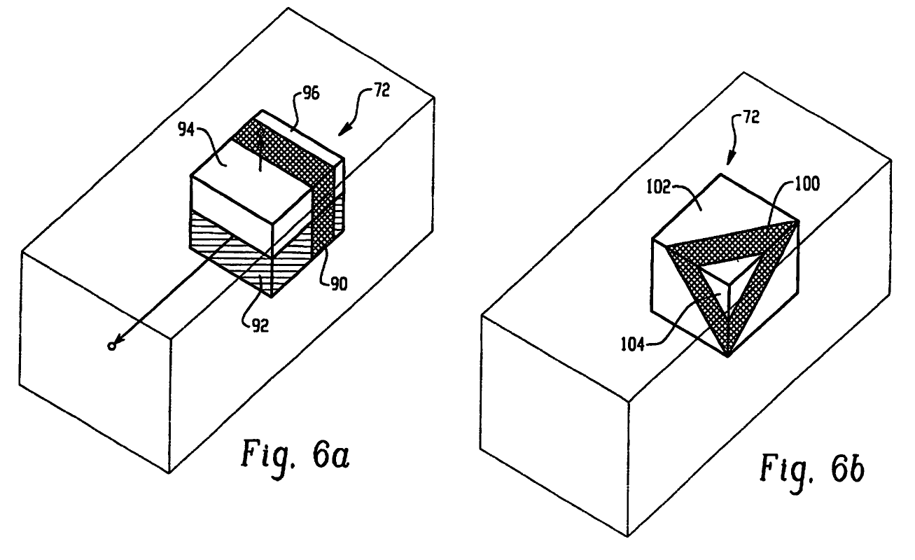

FIGS. 6a and 6b show examples of the completion cube displayed following axial/coronal reviews and after an oblique MPR review of the patient image, respectively;

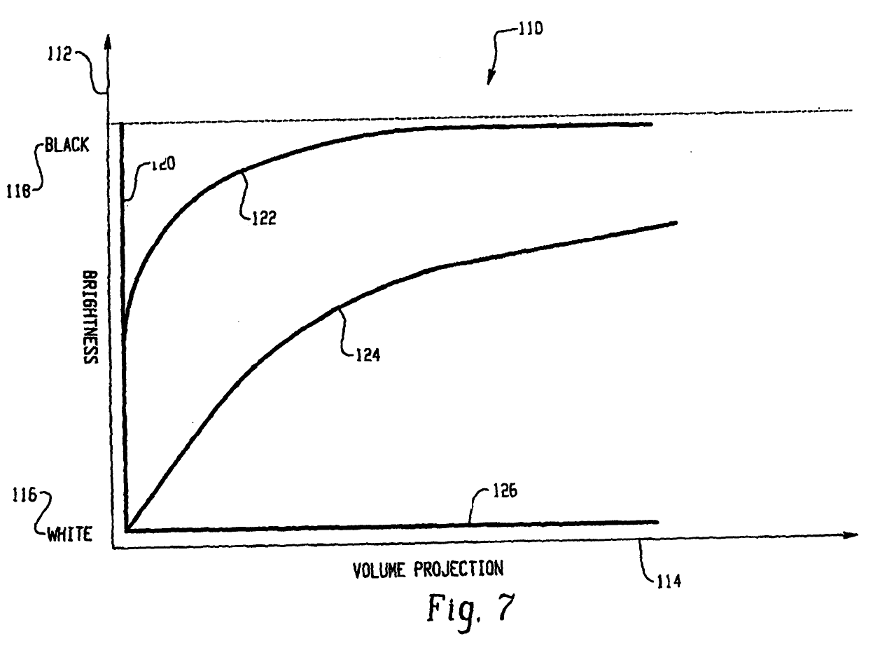

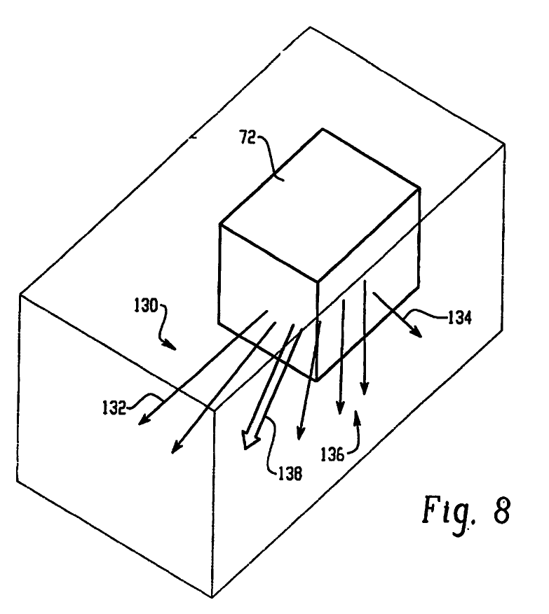

FIG. 7 is a chart illustrating the preferred shading function used in the invention;

FIG. 8 illustrates an embodiment of the completion cube including indicia representative of projection angles used during full volume projection review;

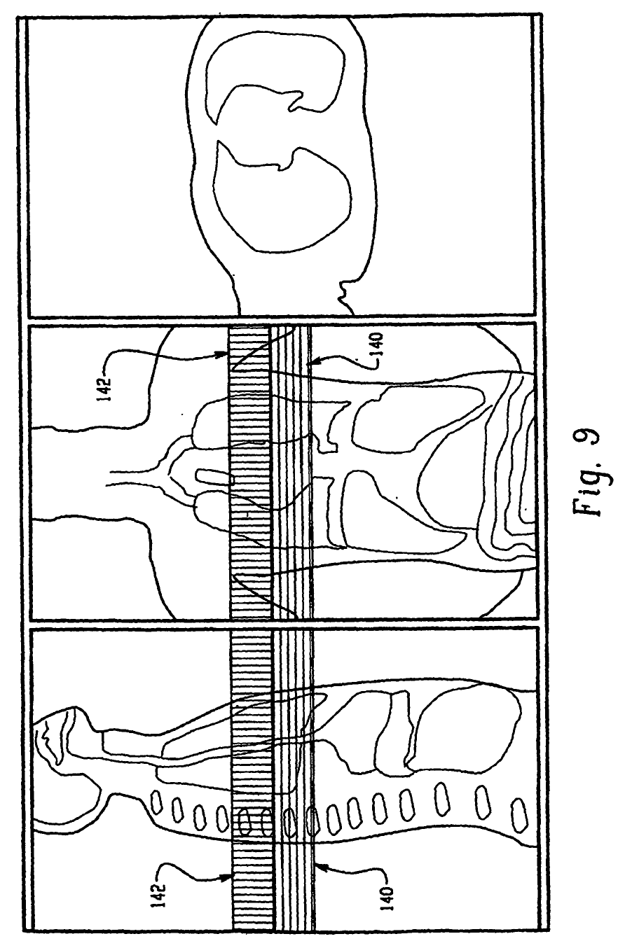

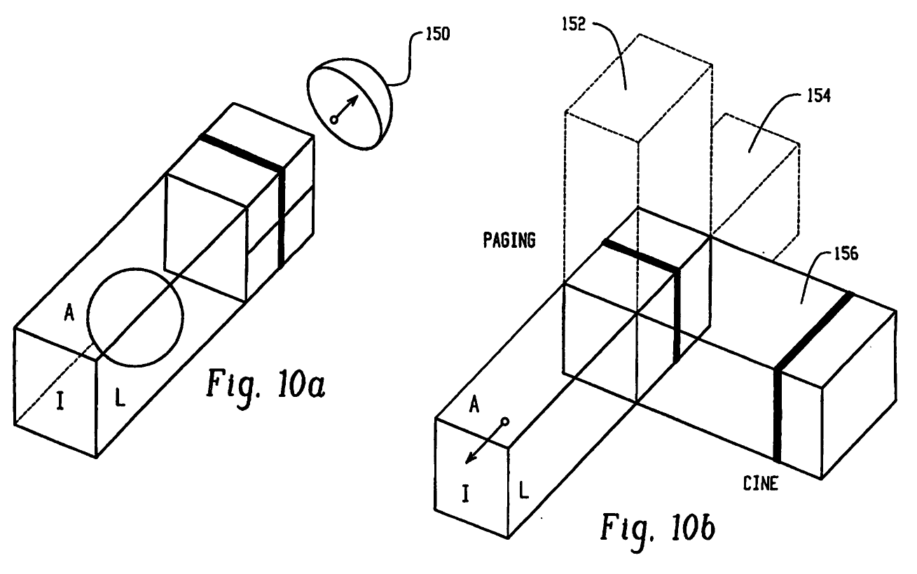

FIG. 9 shows an alternative embodiment of a colorization function; and,

FIGS. 10a and 10b illustrate alternative embodiments including a spherical completion cube representation and a projection completion cube representation.

Referring now to the drawings wherein the showings are for the purposes of illustrating the preferred embodiment of the invention only and not for purposes of limiting same, with reference first to FIG. 1, an imaging system 10 includes a scanning device 12 and a workstation 12. A patient table or support 14 includes a patient supporting surface 16 that is mounted for longitudinal movement relative to a base portion 18. The base portion 18 includes a motor (not shown) for raising or lowering the patient support surface 16 and for moving the patient support surface longitudinally. Position encoders are also provided for generating electrical signals indicative of the height and longitudinal position of the patient support.

The scanning device 12 is preferably, a CT volumetric diagnostic imaging apparatus 20 is disposed in axial alignment with the patient table such that a patient or subject on the patient support surface 16 can be moved into and through a bore 22 of the volumetric imager. In the illustrated embodiment, the volumetric imager is a CT scanner which includes an x-ray tube mounted for repeated circular travel within a preselected plane. The x-ray tube projects a fan-shaped beam of radiation through a ring 24 of radiation translucent material, through the patient support 16, through a region of interest of the subject, and to a ring or arc of radiation detectors positioned opposite the x-ray tube. As the x-ray tube rotates within the plane, a series of data lines are generated, which data lines are reconstructed into at least a slice image by a reconstruction processor included in a control console 26 of the workstation 12. The control console is typically remotely located in a shielded room adjacent the scan room containing the imaging apparatus 10. More specifically to the preferred embodiment, the patient support 16 moves longitudinally as the x-ray tube is rotating around the subject such that a selected volume of the patient is scanned along a spiral path or a series of slices. The position of the x-ray tube is monitored by a rotational position encoder, and the longitudinal position of the patient support is monitored by a longitudinal position encoder within the table 14. The reconstruction processor reconstructs a volumetric image representation from the generated data lines. The control console 26 typically includes one or more monitors 28 and various standard operator inputs, such as a keyboard, trackball, mouse, or the like.

Turning now to FIGS. 2 and 3, a preferred method of clinical review of images of patients will be described. The method 30 includes a first step 32 of generating an image volume data set 52 (FIG. 3) of the patient using the associated scanner device 20 described above and illustrated in FIG. 1. The image volume data set is stored in a memory for use by a radiologist at a workstation 12 to review the images of the patient.

At step 34, using an associated input device 54 such as a mouse or the like a first portion of the image volume data set 52 is selected. A display processor 56 of the workstation 50 is used in step 36 to display the selected portion of the image volume data set 52. The first portion is displayed on a display device 58 including a first screen portion 60 for displaying a slice or other view of the patient taken from the image volume data set and also including a second screen portion 62 for displaying a completion cube image in accordance with the invention in a manner to be described below. It is to be appreciated that the display device 58 may be the monitor 28 of the workstation 12 adjacent the imaging device 20, or it may be a stand-alone apparatus remote from the imaging system 10.

A mapping processor 64 is used in step 38 to map the selected first portion of the image volume data set to a corresponding first portion of a volume completion data set 66. Preferably, the mapping is non-overlapping transform of a sub-volume on a volume representation of the image data set referred to in this application as a completion cube. Also preferably, the mapping processor 64 utilizes a shading function 66 to be described in greater detail below for purposes of shading or colorizing portions of the volume completion data set corresponding to portions of the image volume data being reviewed by the radiologist.

Lastly with regard to the preferred method 30, in step 40, the volume completion data set 66 is displayed on the second screen portion 62 of the display device 58 with the first portion of the volume completion data set according to the predetermined colorization function 58 to visually differentiate the selected first portion of the volume completion data set 52 from the remaining portion of the volume completion data set.

It is to be appreciated that the preferred method of clinical review of images of patients described above in connection with FIGS. 2 and 3 is extended in an alternative embodiment to cover the case of a ?dynamic? clinical review. More particularly, in cardiac investigations, gating is often used during the EKG cycle to trigger the scanning device resulting in multiple image volume data sets, each taken at a different point in the EKG cycle. As an example, fifteen (15) or more image volume data sets may be stored in the imaging device. In the alternative embodiment described herein, a separate volume completion data set is provided in a corresponding relationship to each of the image volume data sets collected from the patient. As each of the image volumes are reviewed in turn by the radiologist, the display step 36, the mapping step 38, and the colorization and shading step 40 described above in connection with the ?static? clinical investigation is repeated for each of the image volume data set/volume completion data set pairs. In that way, the radiologist can be certain that each image taken at each point in the subject multi-phasic study has been adequately reviewed.

In the case of liver scans as another example of the alternative embodiment, a set of three (3) image volume data sets are acquired at each liver phase including a hypatic enhancement, portal enhancement, and non-arterial enhancement phase. A corresponding set of three (3) volume completion data sets are also provided in a corresponding relationship with each acquired image volume data set during the three (3) liver phases. The display mapping and colorization and shading steps described above in connection with the static investigation are repeated as the investigation by the radiologist unfolds.

As a final but not exhaustive list of examples of the alternative embodiment of the use of the subject invention to perform multi-phasic studies, the volume completion cube can be used in investigations made using images with contrast and without contrast as well as images taken sometime in the past against images taken in the future such as to determine the effectiveness of chemotherapy or other treatments.

FIGS. 4a and 4b illustrate the images 70, 72 displayed on the first and second screen portions 60, 62 of the display device 58 during a typical patient image volume review by a radiologist. More particularly, as the radiologist displays images 70 such as sections, slabs, projections, etc. of the patient's image volume data set 52 on a display port 60, a supplemental graphical representation of the image volume in the form of a completion cube 72 is updated in a separate viewport 62 of the display device 58 to indicate those aspects of the data set which have been reviewed, how much time has been spent in reviewing each portion, and a level of detail of review thereof. The preferred mode of operation of the invention is to map, using the mapping processor 64 each image in the display viewport 60 with a unique mapping to the volume completion data set 66 which is displayed in the second viewport 62 as a completion cube in accordance with a shading or colorization function 68. It is to be appreciated that the mapping/projection is the intersection of the completion cube with the sub-volume being displayed which may be an axial slice, a slab, volume projections, oblique MPR views, MPRs, or a cine display. The projections on the completion cube are automatically shaded or colorized according to the colorization function 68 to indicate the amount of time the image is displayed or, more appropriately, to indicate the level of focus or the attention paid by radiologists on selected portions of the image volume.

FIGS. 5a-5d illustrate a sequence of completion of a shading of the completion cube 72 representing a review of axial images conducted by a radiologist. In the example illustrated in those figures, the review process of the patient case is from superior to inferior. Also, it is to be appreciated that the axial planes or sections intersect the completion cube 72 on sagittal and coronal sides since the axial planes are perpendicular with the sagittal and coronal axes. It is advantageous that all three (3) sides of the completion cube are presented to the radiologist. The views contained within the cube are projected to the faces of the cube to be readily identified.

The empty or unshaded completion cube 72 illustrated in FIG. 5a is indicative that none of the patient image volume data set has yet been reviewed. Labels 74 may be added to the completion cube representative of anatomical labels such as illustrated including ?D?, ?I?, ?R? as illustrated. Also, indicia 76, preferably in the form of an arrowhead is used in conjunction with the completion cube 72 displayed on the viewport 62 of the display device 58 to assist the radiologist in understanding the things displayed during patient image volume review.

FIG. 5b shows the completion cube 72 with a first portion 76 thereof shaded representative of the review of a plurality of axial slices of the image volume data set having been reviewed by the radiologist. As further shown in that figure, the axial plane is ?framed? using darkened regions 80 to further assist the radiologist in examining the image volume.

FIGS. 5c and 5d illustrate the completion cube 72 in various stages of shading including the first portion 78 discussed above, a second portion 82 and a third portion 84. As can be seen, the second portion of shading 82 of the completion cube 72 is lighter than the first and third portions 78, 84 indicating that a potentially under-reviewed sub-volume of the image volume data set exists. Again, preferably, the shading represents the amount of time or focus that has been spent on any sub-volume in the image volume data set. FIG. 5d shows that a potentially under-reviewed sub-space of the image volume data set exists.

FIGS. 6a and 6b show the subject completion cube shaded in accordance with the present invention as a result of various selectable clinical evaluations of the patient image volume. More particularly, as illustrated in FIG. 6a, the completion cube 72 includes a first shaded portion 90 resulting from an axial review of the image volume data set and a second shaded portion 92 resulted from a coronal review of the image volume. As can be seen, third and fourth portions 94, 96 of the completion cube 72 remain unshaded. This of course indicates that portions of the image volume data set have not been reviewed at all by the radiologist. Further, as shown in FIG. 6a, the first portion of the completion cube 72 is shaded darker than the second portion 92. This indicates that the radiologist spent more time in conducting the axial review of the first portion of the image volume data set than conducting the coronal review of the second portion of the image volume data set. Lastly, it is also to be observed that at least one portion of the image volume data set was reviewed by the radiologist twice, first in the axial review, and then in the coronal review. More particularly, the overlap between the first portion 90 and the second portion 92 of the shading in the completion cube 72 clearly shows this.

FIG. 6b illustrates a completion cube 72 in accordance with the invention wherein the image volume review was conducted using an oblique MPR review process. As shown, a shaded region 100 bisects the completion cube 72 at an oblique angle and divides the cube into a large first portion 102 and a smaller second portion 104.

Turning now to FIG. 7, the preferred form of the shading function 68 will be described with reference to a plurality of shading curves 110 plotted on a Cartesian coordinate graph including a brightness dimension 112 on the ordinate and a time dimension 114 on the abscissa. As be seen, the brightness axis ranges from a white 116 or no shading end to a black 118 end. A first curve 120 illustrates that the preferred embodiment of the shading function 68 shades quickly when a thin slice is viewed by the radiologist on the display device. As can be seen, the curve 120 is substantially vertical and transitions quickly to the black 118 end of the axis. Second and third curves 122, 124 show that the grey scale shading function fills in, colorizes, or otherwise shades portions of the completion cube less quickly as the slice or volume portion of the image volume increases. As noted above, preferably, the shading in the volume completion cube is representative of the time spent or the attention given per volume measure of the image volume. Accordingly, as the slice thickens the attention given to the volume image on the display on a volume basis is automatically decreased and, therefore, for full colorization or scaling to occur, that image must be displayed for longer periods of time. Accordingly, as can be seen, a thick slice generates a curve as shown at reference numeral 122 and thicker slices fill in at a rate substantially as indicated at curve 124. At an extreme, if the entire image volume is displayed, the preferred grey scale shading function is representative at curve 126. This is the case where the attention or focus is not confined to small thin slices but, rather, the study substantially loses focus because the entire image volume is displayed.

It is to be appreciated that several shading functions can be defined which represents the amount of time spent reviewing each slice. The curves shown in FIG. 7 take into account the thicknesses of the slices being reviewed. As an example, using a fast cine through thick slabs would dark-shade the completion cube more slowly than if thin slices were reviewed one image at a time. This shading function holds for full-volume projection, the limit of the thick slice as represented in curve 126. In this review process, the shading function may never reach the dark side regardless of how long the view is displayed by the radiologist on the display device.

FIG. 8 illustrates another preferred aspect of the invention in the case of a full volume projection review by the radiologist. Turning now to that figure, the completion cube 72 is illustrated in a partially shaded condition with a plurality of arrows or vectors 130 extending from the cube. In this embodiment, the set of arrows represents the projection angles used during volume image review by the radiologist. The arrows provide feedback concerning the projection angles used as the entire image volume is reviewed by the radiologist in its entirety. A first arrow 132 was considered by the radiologist from an axial perspective. A second arrow 134 shows that the entire image volume was reviewed by the radiologist from a sagittal perspective. A plurality of third arrows 136 show that the radiologist viewed the patient image volume from perspectives ranging from sagittal to axial. A particular arrow 138 is marked with indicia shown in the figure as a dot and dash line representative of the radiologists marking that perspective of the image volume for further review. Preferably, the arrows, their directions, and relationships to the volume completion cube are stored in the memory of the workstation 50.

FIG. 9 shows an alternative embodiment wherein a colorized function is used in place of the shading function described above. As shown there, the volume representation for completion feedback are volume-centered planar axial, sagittal, and coronal slices rather than the cube described above. As aspects of the image volume are displayed/read such as slices, slabs, MPRs, etc., they are projected to the axial, sagittal, and coronal planes i.e., anatomical reference view ports using intersection, and the projections are colorized according to review time. For example, a read overlay 140 on the CT number, for instance, indicates the amount of time spent, and the blue overlay 142 may represent an under-reviewed aspect of the volume.

With reference lastly to FIGS. 10a and 10b, further alternative embodiments of the invention are illustrated. In FIG. 10a, a sphere 150 is used in place of the volume completion cube described above when representing angles which projection angles have been used during image volume review. In FIG. 10b, multiple completion cubes 152-156 are used for various search methods.

The invention has been described with reference to the preferred embodiment. Obviously, modifications and alterations will occur to others upon reading and understanding this specification. It is intended to include all such modifications and alterations insofar as they come within the scope of the appended claims or the equivalence thereof.

1. A system (50) for auditing review of images of a patient, the system (50) comprising:
a source of an image volume data set (52) of the patient;
a display device (58);
a display processor (56) for selectively displaying a first portion of the image volume data set (52) on the display device (58);
a source of a volume completion data set (66); and,
a mapping processor (64) for performing a mapping transformation of said first portion of the image volume data set (52) displayed on the display device (58) into a first portion of the volume completion data set (66) to store in the volume completion data set a record that said first portion of the image volume data set (52) was displayed on said display device (58).

2. The system (50) according to claim 1 wherein the display processor (56) is adapted to display the volume completion data set (66) on said display device (58) as a completion cube image (72) with a first portion of the completion cube image (72) corresponding to said first portion of the completion data set 66 being shaded relative to the remaining portion of the completion cube image (72) to visually identify said first portion of the image volume data set (52) being displayed against the remainder of the image volume data set (52) not being displayed.

3. The system (50) according to claim 1 wherein the mapping processor (64) is adapted to perform said mapping transformation in conjunction with a shading function (68) to map said first portion of the image volume data set (52) together with data relating to a level of review focus of the displayed first portion of the image volume data set (52) into said first portion of the volume completion data set (66).

4. The system (50) according to claim 3 wherein said data relating to said level of review focus includes review audit information of a volume of said image volume data set (52) displayed on said display device (58) per a length of time said volume of said image volume data set (52) is displayed on said display device (58).

5. The system (50) according to claim 4 wherein the display processor (56) is adapted to display the volume completion data set (66) on said display device (58) as a completion cube image (72) with a first portion of the completion cube image (72) corresponding to said first portion of the completion data set (66) being shaded relative to the remaining portion of the completion cube image (72) in accordance with said review audit information to visually identify said first portion of the image volume data set (52) being displayed against the remainder of the image volume data set (52) not being displayed.

6. The system (50) according to claim 4 wherein the display processor (56) is adapted to display the volume completion data set (66) on said display device (58) as a completion cube image (72) with a first portion of the completion cube image (72) corresponding to said first portion of the completion data set (66) being colorized relative to the remaining portion of the completion cube image (72) in accordance with said review audit information to visually identify said first portion of the image volume data set (52) being displayed against the remainder of the image volume data set (52) not being displayed.

7. The system (50) according to claim 1 further including:
an input means (54) operable by an operator of the system (50) to select a plurality of views of said image volume data set (52) of the patient corresponding to a plurality of portions of said image volume data set (52), and wherein the display processor (56) is adapted to display each of said plurality of views of the image volume data set (50) on the display device (58) as the plurality of views are selected by the operator using the input means (54), and the mapping processor (64) performs said mapping transformation of each of said plurality of portions of the image volume data set (52) displayed on the display device (58) into a plurality of portions of the volume completion data set (66) as said record that said plurality of views of the image volume data set (50) were displayed on said display device (58).

8. The system (50) according to claim 7 wherein:
the mapping processor (64) is adapted to perform said mapping transformation in conjunction with a shading function (68) to map said plurality of portions of the image volume data set (52) together with data relating to a level of review focus of the displayed plurality of portions of the image volume data set (52) into a corresponding plurality of portions of the volume completion data set (66); and,
the display processor (56) is adapted to display the plurality of portions of the volume completion data set (66) on said display device (58) as a completion cube image (72) with portions of the completion cube image (72) corresponding to said plurality of portions of the completion data set (66) being shaded relative to the remaining portion of the completion cube image (72) to visually identify said plurality of portions of the image volume data set (52) having been displayed against the remainder of the image volume data set (52) not having been displayed.

9. The system (50) according to claim 8 wherein:
the source of said image volume data set (52) is a scanning device (20) adapted to scan said patient and generate said image volume data set (52); and,
said plurality of views of said image volume data set (52) include at least one of:
a slice through said image volume data set (52);
a slab through said image volume data set (52); and,
planar MPR views including axial, sagittal, and coronal.

10. A method of auditing review of images of a patient, the system comprising:
providing a source of an image volume data set (52) of the patient;
providing a display device (58);
using a display processor (56), selectively displaying a first portion of the image volume data set (52) on the display device (58);
providing a source of a volume completion data set (66); and,
using a mapping processor (64), performing a mapping transformation of said first portion of the image volume data set (52) displayed on the display device (58) into a first portion of the volume completion data set (66) to store in the volume completion data set a record that said first portion of the image volume data set (52) was displayed on said display device (58).

11. The method according to claim 10 further comprising:
using the display processor (56), displaying the volume completion data set (66) on said display device (58) as a completion cube image (72) with a first portion of the completion cube image (72) corresponding to said first portion of the completion data set 66 being shaded relative to the remaining portion of the completion cube image (72) to visually identify said first portion of the image volume data set (52) being displayed against the remainder of the image volume data set (52) not being displayed.

12. The method according to claim 10 further comprising:
using the mapping processor (64), performing said mapping transformation in conjunction with a shading function (68) to map said first portion of the image volume data set (52) together with data relating to a level of review focus of the displayed first portion of the image volume data set (52) into said first portion of the volume completion data set (66).

13. The method according to claim 12 wherein the step of mapping using said data relating to said level of review focus includes mapping using review audit information of a volume of said image volume data set (52) displayed on said display device (58) per a length of time said volume of said image volume data set (52) is displayed on said display device (58).

14. The method according to claim 13 further comprising:
displaying the volume completion data set (66) on said display device (58) as a completion cube image (72) with a first portion of the completion cube image (72) corresponding to said first portion of the completion data set (66) being shaded relative to the remaining portion of the completion cube image (72) in accordance with said review audit information to visually identify said first portion of the image volume data set (52) being displayed against the remainder of the image volume data set (52) not being displayed.

15. The method according to claim 13 further comprising:
displaying the volume completion data set (66) on said display device (58) as a completion cube image (72) with a first portion of the completion cube image (72) corresponding to said first portion of the completion data set (66) being colorized relative to the remaining portion of the completion cube image (72) in accordance with said review audit information to visually identify said first portion of the image volume data set (52) being displayed against the remainder of the image volume data set (52) not being displayed.

16. The method according to claim 10 further including:
using an input means (54) operable by an operator of the system (50), to selecting a plurality of views of said image volume data set (52) of the patient corresponding to a plurality of portions of said image volume data set (52), displaying each of said plurality of views of the image volume data set (50) on the display device (58) as the plurality of views are selected by the operator using the input means (54), and performing said mapping transformation of each of said plurality of portions of the image volume data set (52) displayed on the display device (58) into a plurality of portions of the volume completion data set (66) as said record that said plurality of views of the image volume data set (50) were displayed on said display device (58).

17. The method according to claim 16 further comprising:
using the mapping processor (64), performing said mapping transformation in conjunction with a shading function (68) to map said plurality of portions of the image volume data set (52) together with data relating to a level of review focus of the displayed plurality of portions of the image volume data set (52) into a corresponding plurality of portions of the volume completion data set (66); and,
using the display processor (56), displaying the plurality of portions of the volume completion data set (66) on said display device (58) as a completion cube image (72) with portions of the completion cube image (72) corresponding to said plurality of portions of the completion data set (66) being shaded relative to the remaining portion of the completion cube image (72) to visually identify said plurality of portions of the image volume data set (52) having been displayed against the remainder of the image volume data set (52) not having been displayed.

18. The method according to claim 17 further comprising:
providing the source of said image volume data set (52) using a scanning device (20) adapted to scan said patient and generate said image volume data set (52); and,
displaying said plurality of views of said image volume data set (52) includes displaying at least one of:
a slice through said image volume data set (52);
a slab through said image volume data set (52); and,
planar MPR views including axial, sagittal, and coronal.

19. A method of clinical review of images of patients comprising:
providing an image volume data set of an anatomical structure;
displaying a plurality of selectable portions of said image volume data set on a human readable display; and,
storing data identifying each of said plurality of selectable portions displayed on the human readable display.

20. A method comprising:
using an associated scanner device, generating an image volume data set of a patient on the scanner device and storing the image volume data set in a memory of the scanner device;
selecting a first portion of the image volume data set using input means of the associated scanner device;
displaying the first portion of the image volume data set as a first image of the patient on a human readable display of said associated scanner device;
mapping said first portion of the image volume data set to a first portion of a volume completion data set; and,
displaying said volume completion data set with said first portion of the volume completion data set identified according to a predetermined colorization function to visually differentiate said first portion of the volume completion data set from the remaining portion of the volume completion set.
